(19) United States
(12) Patent Application Publication
(10) Pub. No.: US 2014/0163437 A1
(43) Pub. Date: Jun. 12, 2014

(54) PERINEAL MASSAGE DEVICE

(71) Applicant: ReJuVey, LLC,, Seattle, WA (US)

(72) Inventors: Christoph Mack, Seattle, WA (US); Richard T. Able, Tacoma, WA (US)

(73) Assignee: ReJuVey, LLC,, Seattle, WA (US)

(21) Appl. No.: 14/047,942

(22) Filed: Oct. 7, 2013

Related U.S. Application Data
(60) Provisional application No. 61/710,388, filed on Oct. 5, 2012.
(60) Provisional application No. 61/725,759, filed on Nov. 13, 2012.

(51) Int. Cl. A61H 23/02

(52) U.S. Cl. CPC A61H 23/02
USPC 601/46

(57) ABSTRACT

A perineal massage device is configured to provide a dilation and massage function for the vaginal opening, particularly including the lower half in the area of a woman's perineum. A preferred version of the device is configured to be able to apply sub-sonic, sonic, and ultrasonic vibrational stimulus and to emit a gel. In some versions, the device may be configured for communication to one or more remote computers, smart phones, or other devices for remote control and sharing of data.

### PRIORITY CLAIM

This application claims the benefit of U.S. Provisional Application Ser. No. 61/710,388 filed Oct. 5, 2012, and U.S. Provisional Application Ser. No. 61/725,759 filed Nov. 13, 2012, the contents of both of which are hereby incorporated by reference.

### FIELD OF THE INVENTION

This invention relates generally to devices for performing perineal massage.

### BACKGROUND OF THE INVENTION

Perineal massage (PM) generally involves massaging a woman's perineum around the opening to the vagina. PM is often recommended in preparation for childbirth, in hopes that pre-stretching the tissue will decrease tearing and other trauma during delivery. Some medical practitioners advise that PM may reduce the likelihood of an episiotomy, reduce the stinging sensation during crowning, and help pregnant women to become more familiar with stretching sensations of birth in order to more easily relax those muscles during childbirth. Although the literature is mixed about the effectiveness of PM, it is largely believed to be that poor compliance and inconsistencies in force, duration, and pattern of massage in conducting the exercise severely limits positive outcomes. Current devices and techniques for performing PM are inadequate to enable PM to be conducted in a consistent and effective way.

### SUMMARY OF THE INVENTION

The various preferred versions of the invention as described below relate to devices for conducting perineal massage. A preferred PM device is configured to provide a dilation and massage function for the vaginal opening, particularly including the lower half in the area of a woman's perineum. As described further below, the device is configured to be able to apply sub-sonic, sonic, and ultrasonic vibrational stimulus, gentle heat, and soothing solutions tailored to promoting tissue resiliency.

In accordance with some preferred versions of the invention, the device is configured with a tip and a main body for housing a motor, power supply, and other components.

In some versions, the main body or housing is removably attachable to a support post which extends upward in a substantially perpendicular fashion from a base platform. The housing may be pivotally mounted on the support post at a pivot location, which may also be configured for rotational adjustment of the housing with respect to the post.

In yet other versions, the support post is telescopically or otherwise adjustable in height, thereby allowing a user to increase or decrease a distance between the device and the platform.

Other preferred versions of the invention are hand-operable, either in a form in which the device is detached from the support post or without being configured for use with a support post.

The device in some embodiments includes a sonic rod received within a sleeve formed in a wand that is removably attached to the handle of the device. Optionally, a passageway may be formed in the wand to allow for the insertion of a gel that can be communicated through the passageway and through holes formed in the tip of the wand.

In yet other embodiments of the invention, the device may be remotely controlled by a remote computer, a smart phone, or other devices. In some instances, particular programming regimens may be stored on the device, on the remote controller, or both, allowing for selection and operation of particular programming regimens.

In still other versions of the invention, the device is in communication over a network to one or more remote computers for collecting regimens, feedback, and other user information from a plurality of users of similar devices. The collected information may be used by individual users to evaluate regimens and techniques that are effective, as well as to allow health care providers to evaluate individual compliance with recommended uses of the device.

### BRIEF DESCRIPTION OF THE DRAWINGS

Preferred and alternative examples of the present invention are described in detail below with reference to the following drawings:

FIG. 1 is a perspective view of a preferred device for use in perineal massage in accordance with the present invention.

FIG. 2 is an illustration of a preferred system incorporating a perineal massage device together with one or more additional devices such as a smart phone, computer, and remote server.

FIG. 3 is a block diagram of the components of a preferred perineal massage device in accordance with the invention.

FIG. 4 is an illustration of a smart phone containing applications for use with a preferred perineal massage device.

FIG. 5 is an illustration of a smart phone application interface for use with a preferred perineal massage device.

FIG. 6 is an illustration of a computer for use in tracking, monitoring, or storing data from a preferred PM device.

FIG. 7 is a perspective view of an alternate version of a hand-held device for perineal massage.

FIG. 8 is a perspective view of the device of FIG. 7, shown being held by a hand.

FIG. 9 is an exploded perspective view of the device of FIG. 7.

FIG. 10 is an exploded perspective view of the device of FIG. 7, shown together with a preferred charging station.

FIG. 11 is an exploded view of an alternate version of a device for perineal massage.

FIG. 12 is a perspective view of an alternate version of a device for perineal massage.

### DETAILED DESCRIPTION OF THE PREFERRED EMBODIMENT

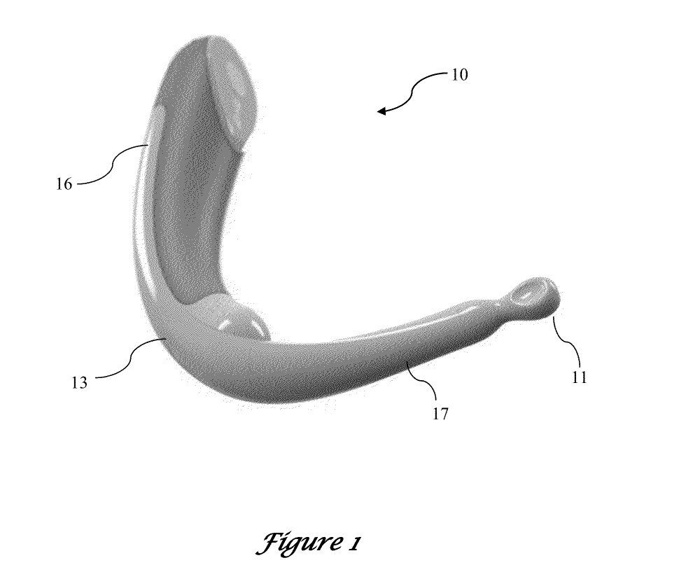

With reference to FIG. 1, a preferred PM device 10 is configured to provide a dilation and massage function for the vaginal opening, particularly including the lower half in the area of a woman's perineum. As described further below, the device is configured to be able to apply sub-sonic, sonic, and ultrasonic vibrational stimulus, gentle heat, and soothing solutions tailored to promoting tissue resiliency.

As illustrated in FIG. 1, a preferred device 10 is configured with main body 13 housing a motor, power supply, and other components as described further below. The main body includes a handle portion 16 and a wand portion 17, with the wand terminating in a tip 11 at the distal end.

In one alternate version of the invention, the housing is removably attachable to a support post which extends upward in a substantially perpendicular fashion from a base platform. In some versions the housing is pivotally mounted on the support post at a pivot location, which may also be configured for rotational adjustment of the housing with respect to the post. In yet other versions, the support post is telescopically or otherwise adjustable in height, thereby allowing a user to increase or decrease a distance between the device and the platform.

The version incorporating a support post and platform is preferably used by placing the platform on a stable surface such as the floor or a mattress. The user is then able to place her buttocks on the platform, thereby providing a stable support for the device with respect to the user. The post is then raised or lowered as necessary and the housing is angularly or rotationally adjusted as appropriate in order to use the device. Because the device is mounted at a height, distance, and angle suitable for performing PM, the stability of the platform beneath the user allows for hands-free operation.

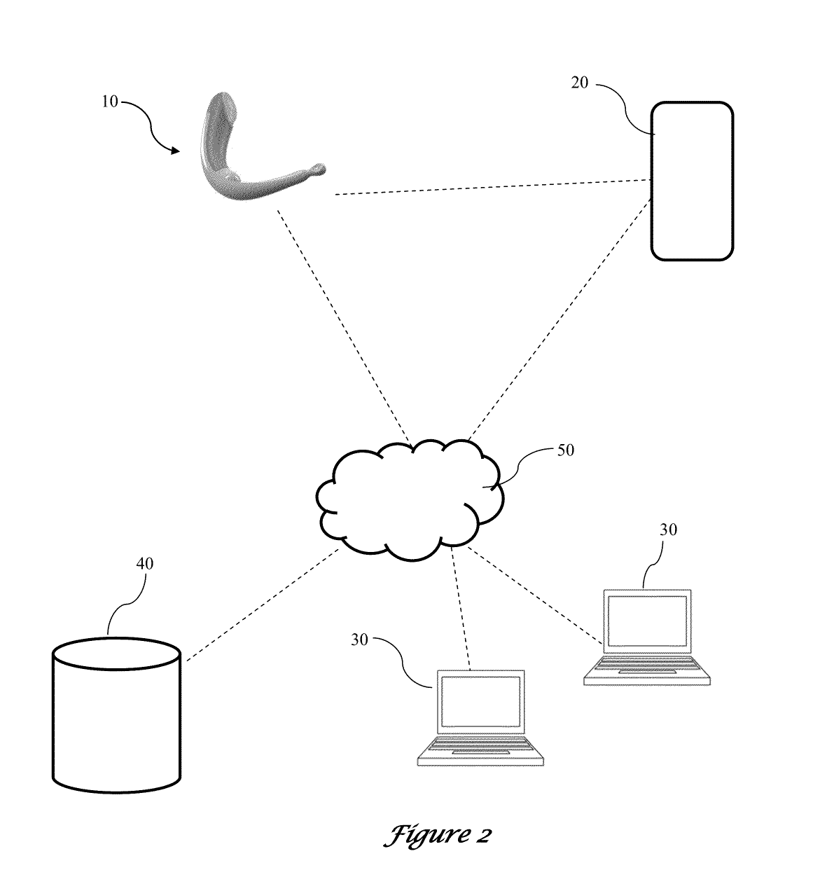

In other versions the perineal massage device 10 is configured as a hand-held wand as shown in the accompanying figures, rather than a platform-mounted device. Either version of the device may be controlled during operation through a remote controller such as a smart phone programmed with an application for controlling the device. Thus, in a preferred version as illustrated in FIG. 2, the device (or wand) 10 is configured for communications with a variety of other devices, preferably in a wireless manner but optionally using wired connections. It should be appreciated that each of the communications links shown in FIG. 2 may occur in a wired or wireless fashion, and that the wireless transmissions may be over Wi-Fi, Bluetooth, or any other format for enabling wireless devices to communicate with each other.

As shown, the wand may be configured to wirelessly communicate with an electronic controller that is preferably a smartphone 20. Such communication may occur in a direct fashion (such as with Bluetooth), or may occur over a local area network or a wide area network such as the Internet 50. The device may also be configured to communicate with one or more remote computers 30, allowing the wand to be controlled or programmed by such remote computers, for example for transferring exercise regimens from the remote computer to the wand. Likewise, data collected from the wand may be transferred to the remote computer for subsequent storage and analysis.

Still further, data from one or more wands 10 may be transferred to a remote server 40 or other accessible storage media in a similar fashion. The remote server may further allow interaction among various users of similar wands, providing a means for transferring stored exercise programs and for sharing experiences among users. Likewise, the aggregation of collective user data may facilitate analysis of consistency in which users follow PM regimens and the effectiveness of those regimens, for example by comparing results experienced by different users.

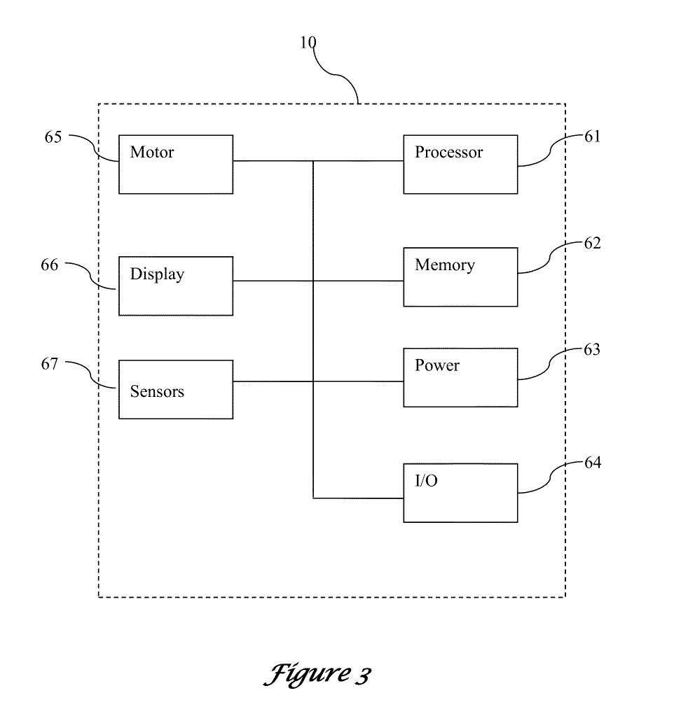

As shown in FIG. 3, the wand or device 10 includes an internal processor 61 and memory 62 for storing programming instructions and data related to the operation of the device and feedback to the device. A power supply 63, preferably in the form of rechargeable batteries, is provided for the wand.

The wand includes an input/output (I/O) 64 component for receiving data and instructions externally and for transferring data to remote locations. As explained above, the I/O preferably comprises a wireless transceiver for sending and receiving data wirelessly, such as over a Wi-Fi channel or Bluetooth. The I/O component further includes a direct user interface for controlling the wand, preferably including one or more buttons for controlling and selecting modes of operation, and a display 66 for allowing the user to select and confirm operational choices.

The wand includes sub-sonic, sonic, and ultra-sonic vibration modes, and is preferably driven by low-noise, power efficient actuators similar to those found in existing health care and robotics applications. Actuators for external and internal stimulation will be subject to individual control of intensity, frequency, waveform, and attack/sustain/decay (a/s/d) patterns.

In some versions, the wand is morphologically variable, offering dynamic control of the wand diameter, length, and to a limited degree, shape. Pulsing, growing, bending, and thrusting effects can be controlled individually or as preprogrammed PM regimens. These programs, in turn, can be caused to vary in rhythm, mix, and intensity in response to measured physiological response or to user control inputs.

Preferred PM regimens can be selected from stock libraries or can be customized, composed, rated, stored for future use, and shared with other users. Each of these profiles can be stored locally on the wand in the wand memory. Alternatively, a broader library of profiles can be stored remotely, either on a remote server or on a remote computer or other device such as a smartphone. Profiles stored in such remote locations can be accessed as desired for use later by downloading them to the wand wirelessly from the remote computer, smartphone, or other device.

An internal motor 65 is provided within the wand to cause the wand to move in a variety of directions and in multiple patterns, as desired by the user and as manually directed or as instructed by any of the stored profiles or modes of operation. Preferably the motor is configured to allow vibration, pulsing, gyration, increases in length or width, and other changes in shape or motion.

In some versions, the wand includes one or more sensors positioned on the wand to sense external information such as temperature, pressure (or force), or other environmental parameters experienced by the wand. Each of these sensors is in communication with the processor and memory to store the sensed parameter in association with the operational configuration of the wand at the time. A clock is provided to track the parameters in duration and time of initiation.

Particular versions of preferred sensors are illustrated positioned on an exemplary wand 17 in FIG. 12. In this version, the wand includes a photodetector sensor 73 having an adjacent LED 74 for illumination. The photodetector sensor 73 preferably any suitable form of photodetector such as a CMOS, CCD, or other such sensor configured to be able to detect a surrounding image, and more particularly the color of the image. In the preferred example, the photodetector is quite small, and need only be as large as a single pixel in some versions of the invention. Likewise, the accompanying LED 74 need only be large enough to illuminate enough of the surrounding tissue to allow the photodetector to accurately capture a small image of the tissue sufficient to determine a color for the tissue.

Additional versions of the invention may include a moisture sensor. In the illustrated version, the moisture sensor may be in the form of an adjacent pair of electrical contacts 71, 72, with an accompanying component to detect conductivity levels between the contacts and thereby evaluate moisture levels as a function of conductivity between the contacts.

In yet another version, the sensor may include a pressure or other strain or force sensor 75, such as a load cell, strain gauge, or other such detector capable of monitoring either a degree of force experienced by an external portion of the wand or a degree of bending. Still further, the wand may include a pH sensor positioned on an outer surface of the wand to detect acidity of the fluids in contact with the wand. Though not illustrated, each of these sensors is in communication with the processor located within the housing. In versions in which the wand is removable from the handle, the sensors are preferably in communication via a small electrical connector positioned at an interface between the handle and the wand.

In accordance with some versions of the invention, certain PM regimens may include call and response exercises in which the user is directed to either tense or relax muscle tissues. Sensors (such as the load cell or similar pressure or force sensor) configured on the wand are positioned to detect such changes in force and store the associated data in the memory associated with the wand or transferred to a smart phone or other device. The stored response data is analyzed (either subsequently or in real time) to provide feedback to the user indicating the effectiveness of the user's muscle control in response to the command, for example by indicating the promptness of the response or the strength of the response. Similar data collected over time can be analyzed and presented to the user to indicate improvement over time.

The wand and associated system is configured to facilitate stretching and strengthening of vaginal wall tissue and vasculature through the holistic application of precisely controlled temperature, metered delivery of healing solutions, and ultrasonic therapy. The application of carefully modulated ultrasonic energy, in addition to proven enhancement of absorption of herbal medicines, will also encourage dilation and regeneration of vasculature in surrounding tissues. The resulting increase in blood flow availability, tissue elasticity, tone, and durability will be the key effects of therapies applied through the use of the system.

A variety of exercise functions are possible, tailored to the individual's needs and capabilities. An exemplary exercise is the user controllable expansion in diameter of the wand, triggered through controls located on the wand or through a remote application provided on a smartphone or other device. The wand may also massage in vibrating and rotating modes, in accordance with desired patterns of PM.

Kegel muscle development will be brought to a new level of sophistication, convenience, and effectiveness by the present system. Pressure sensors within the wand, in communication with the processor and stored programming instructions, will monitor force, duration, and cadence of Kegel impulses. The smartphone application will display Kegel performance, and the wand will be able to pulse to lead the user in a “call and response” exercise sets. Users can track their progress over time, and the system can offer prompts and incentive rewards for keeping up the regimen.

In addition to a wand for use as described above, in various configurations the wand and system combine to form an information and data appliance. By integrating the control of the user devices through smartphones, tablets, or other computing devices the system revolutionizes the subtlety and sophistication of control of PM. Smartphone integration also provides the system inherent connectedness to the Internet and therefore to cloud based data constructs.

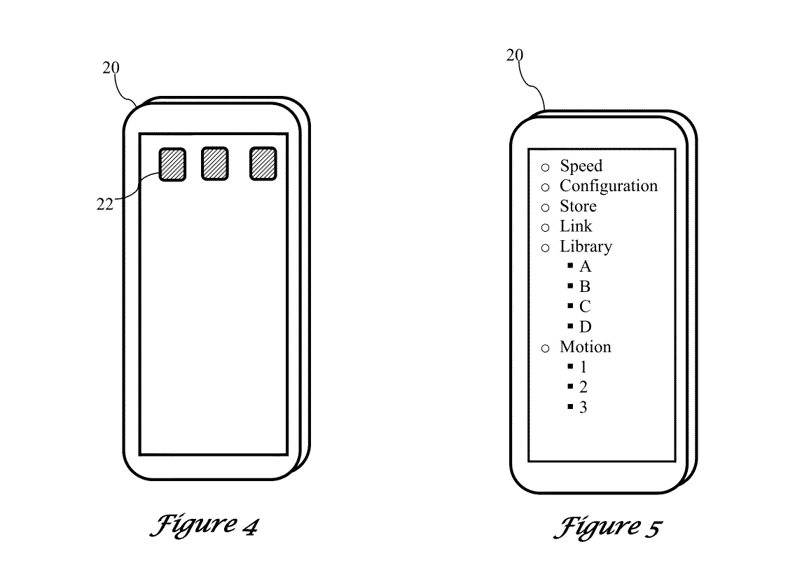

FIG. 4 illustrates a smartphone (or tablet computer or other electronic control device) 20 configured with one or more application programs as represented by icons 22. The application programs on the smartphone include a program configured to interact with the wand to allow for remote control of the wand, data storage and transmission, and creation and transfer of profiles as described above. Thus, the application running on a smartphone may be configured to use commands transmitted using Bluetooth or other formats to communicate directly with the device 10 in order to control the device. Alternatively, the smart phone and the device may each be connected to the same network over a local Wi-Fi system, thereby allowing the application running on the smart phone to control the device over Wi-Fi channels in a local area network. In some versions, the smart phone may be able to control the device across a wide area network such as the Internet.

Most preferably, the smart phone application includes a series of commands causing the device 10 to conduct perineal massage in accordance with a preferred regimen. Thus, for example, the smart phone may include a stored series of instructions for performing PM by the device over a period of time, such as 10 minutes. During that interval, under control of the smartphone application, the wand may perform a series of steps in sequence, such as vibrating, rotating, or increasing in size. Any number of stored PM regimens may be maintained in the memory of the smart phone (or, alternatively, of the device 10), thereby allowing the user to select a currently desired regimen from among the stored library. In accordance with a preferred manner of using the device, the smart phone may include a sequence of stored PM regimens, including an initial introductory regimen which may be shorter in time and have fewer steps, continuing to an ultimate regimen which may be much longer and more rigorous. In a further version, the device, the smart phone, or both may have one or more stored regimens. Where a plurality of regimens is stored on the device, the smart phone may remotely selectively initiate a regimen stored on the device.

In addition to containing controls allowing the user to select and initiate a desired PM regimens, the smartphone application will preferably further include an interface allowing the user to perform any of a number of individual commands in order to control the device in a manual rather than automated fashion. Although the automated PM regimen may be preferred in order to ensure that the user performs the massage consistently and completely, in some instances may be preferable to abort the program regimen and conduct an individually controlled massage. Thus, the smart phone may include an interface allowing the user to command the device to perform any of its individual functions, such as any of its vibration modes, rotating, enlarging, lengthening, or others.

FIG. 5 is a notional representation of an interface containing a menu of functions provided by an application 22 when running on the smart phone 20, and as shown it includes menu-driven commands to control the speed and configuration of the operation of the wand. Further menu-driven commands allow a user to select from among a library of prior regimens (for example, regimens A through D), or to select individual motions in a manually controlled mode. Alternatively, the commands may be otherwise represented, such as in the form of a remote controller having buttons corresponding to speeds, sizes, and modes such as pulsing and the like.

Additional commands within the application enable the smartphone (or tablet) to link to the wand, establishing communication to transfer programs to or from the wand or to transfer data to or from the wand. Stored profiles contained in a library on the smartphone may likewise be transferred to the wand for subsequent operation, or may alternatively be initiated by selecting from among the library of profiles in the application. A further stored listing of motion parameters may include preset modes of operation, such as particular pulsing or vibration modes. As with the library of stored profiles, the various modes may be initiated remotely through the smartphone or downloaded for operation through the wand interface.

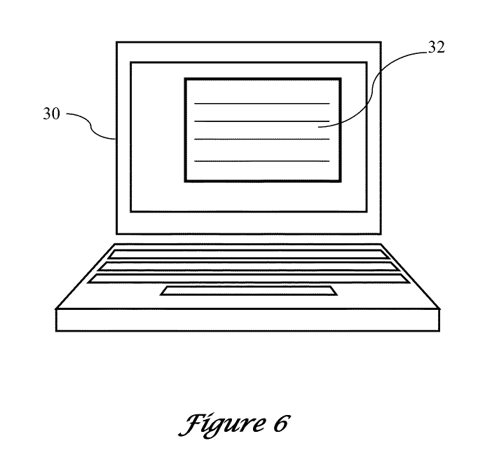

FIG. 6 illustrates a remote computer 30 having a graphic interface 32. The remote computer is preferably configured for communication over a network such as the Internet, and in a preferred version the remote computer is in communication with a remote server 40 containing stored user information and data as desired by the user. The graphic user interface 32 is a representation of a web page sent to the remote computer from the server upon entering a URL, IP address, or the like in a web browser or similar software.

Through the remote computer access to the server, the graphic interface provides a presentation of the user's PM history in using the device, and, in some versions, access to shared libraries of profiles from other users, and a user interface to remotely control and program the wand through the interface. In this regard, each wand is preferably configured with a unique identifier allowing it to be addressable over the network, thereby enabling the user or a health care practitioner to set up a management account to control programming and operation of the wand through the remote computer.

The communication between the device 10 and the remote computer 32 is preferably two-way, in which regimens and control instructions can be sent to the device and sensor and other data can be transferred from the device to the remote computer. Likewise, as yet another example, the device may be used in a manual mode in which the user causes the device to operate in a particular pattern, with the device storing the commands and durations in memory. The user may then save the sequence and timing of commands in the device memory, and optionally transfer them to the remote computer (including a smart phone) for storage as a preferred regimen in the library.

The data transferrable to the remote computer or smart phone may selectively include sensor data captured by the device. Thus, during or after each use the user may cause the device to transfer the photo detector data, which is then stored in the remote computer. Primarily, the remote computer will store an initial captured image as a baseline and compare it with each subsequent image over time. Healthy tissue is often associated with tissue of a particular color, and the comparison of the captured image colors with particular colors understood to be healthy allows the user or a health care professional to evaluate the health of the tissue, including improvements over time.

Similarly, the device may transfer the hydrometer or other moisture data, again allowing for comparison against a baseline and evaluation of the tissue for improvement over time and general health. Transfer of force or strain data likewise allows for evaluation of muscle strength and tissue elasticity, either over time or as compared to a baseline evaluation. In each case, the sensor data is preferably coupled to points in time and associated with uses of the device, to further enable the ability to track usage of the device with changes in sensor data and therefore physiology of the user.

In an optional version of the invention, the remote computer 30 may include a remote computer operated by a healthcare practitioner in order to access user data associated with a device and smart phone, for example as illustrated in FIGS. 2 and 6. In such a version, the device or smart phone may be configured to send user data to the server 40 representative of the use of the device, sensor data collected during use of the device and other parameters. The healthcare provider may then access that data to confirm that a particular user is performing PM in accordance with a prescribed schedule. In the event the user is not meeting the prescribed schedule, the healthcare practitioner may send a message to the user over the smart phone or its application. Similarly, the health care professional can evaluate tissue color, moisture, elasticity, and other physical parameters to further evaluate health issues.

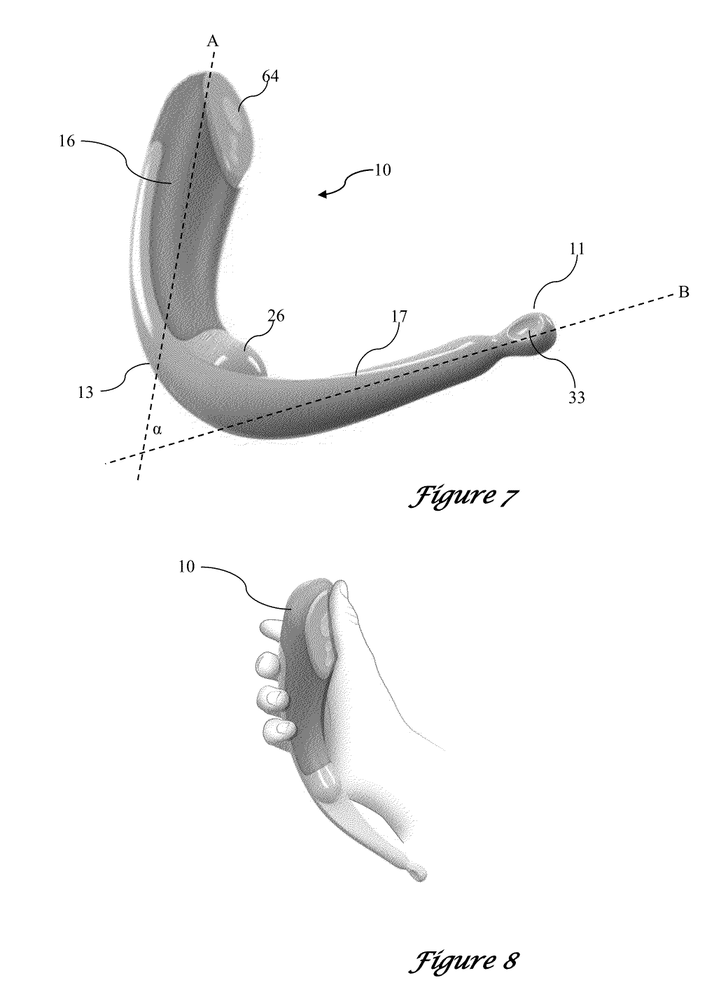

With reference to FIG. 7, a preferred perineal massage device 10 is described below in greater detail. The device is configured with a tip 11 and a main body 13 for housing a motor, power supply, and other components. Although not shown, the housing may be configured to be removably attachable to a support post that can be further attached to a base platform. In the version of FIG. 7, the device forms a handle 16, joining to the wand 17 terminating at the tip 11. The handle generally extends along a first axis A while the wand extends along a second axis B, with axis A intersecting axis B to form an angle α. In the preferred version the intersection angle is in the range of 60 degrees to 120 degrees. In alternate versions the handle and wand are formed at a shallower angle or joint to one another in a generally aligned configuration.

In the example of FIG. 7, the wand 17 is formed from a highly polished plastic, configured to have a smooth, slick surface. At the distal end of the wand, the tip 11 is formed in a tear-drop shape, with a bulbous end at the far distal position and the narrowed end oriented toward the handle to form a narrowed diameter of the wand adjacent to and inward from the tip.

The tip further includes a pair of concavities formed on opposing medial and lateral sidewalls of the tip. One such concavity 33 is visible in FIG. 7 with the other of the pair of concavities being positioned on the opposing sidewall and not visible from the perspective as illustrated. Each concavity is formed to facilitate the placement of a volume of a gel within the concavity if desired prior to use. Preferably the concavity is deep enough to prevent the gel from readily being fully wiped away, and instead allows for the gradual dispersal of the gel over time as the device vibrates.

A user control interface 64 is provided on the distal end of the handle 16 of the device. In the illustrated version, the interface includes a first button configured with a visual indicator such as on/off, 1/0, “play”, or a similar icon or symbol. The first button is coupled to internal components as illustrated in FIG. 3 to cause the device to start and stop a desired regimen or, in the course of fully manual operation, to turn on and turn off. Any number of additional buttons may be provided as part of the interface 64, including for example buttons labeled “+” and “−”, which can be used for increasing and decreasing the vibration intensity, heat, release of gel, or other functionality.

In one version of the invention, one or more buttons (such as the + and − buttons as shown) are configured to allow a user to scroll through a library of stored regimens for use of the device. In such a version, the device may include a plurality of buttons allowing for such library scrolling and for manually operated use, or may alternatively include fewer buttons but with multiple modes of operation.

The other components as illustrated in FIG. 3 are preferably housed within the handle 16 in a preferred configuration. In a version having a display, the display is preferably positioned on an outer surface of the handle; in the illustrated device no display is shown. As described above, the user interface can include any number of buttons or similar user interface devices. The I/O interface as described with respect to FIG. 3 can further include wireless communication components, and in versions including such components they are preferably housed within the handle. Sensors are not illustrated in the version of FIG. 7, but may be included; in the event sensors are desired as described in FIG. 3, such sensors are most preferably incorporated into the wand 17, and may include the tip 11.

In some versions, the handle 16 includes a soft grip formed from silicone, santoprene, or other such materials over-molded onto a portion of the handle which may otherwise be formed from plastic materials.

At a location toward the proximal end of the wand 17, the wand flares outwardly to serve as a physical and visual aid to impede further insertion of the wand. In the version as illustrated in FIG. 7, this flared portion 26 is in the form of a bulbous abutment formed at a juncture where the handle and wand meet.

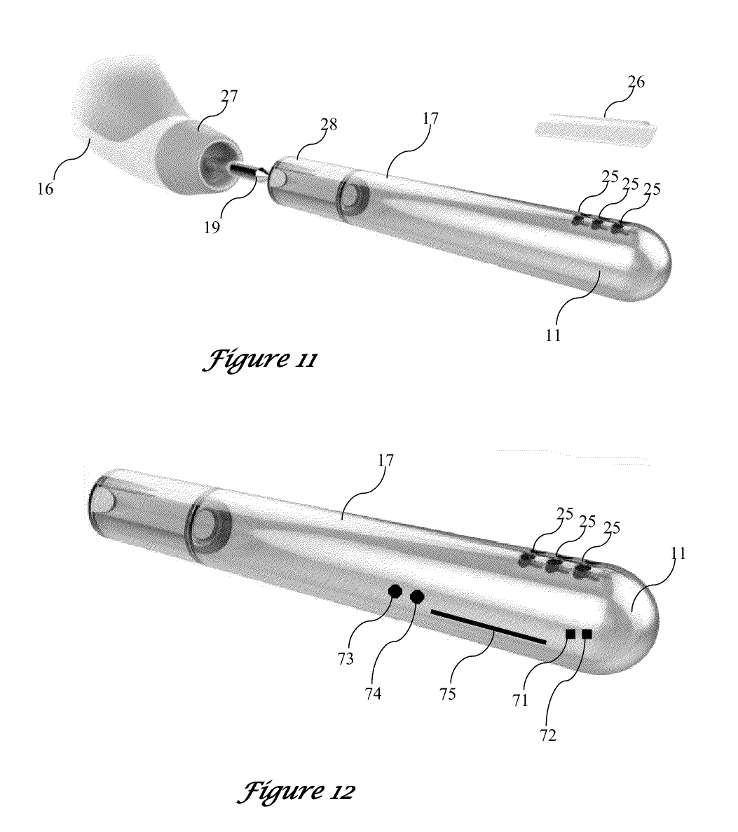

As best seen in the exploded view of FIG. 9, the wand 17 is preferably removably attachable to the handle 16. The motor (not shown) within the handle produces a sonic vibration that is communicated externally to a sonic rod 19 (see also FIG. 11). In operation, the sonic rod 19 vibrates at a high rate, which may be varied, pulsed, and otherwise controlled as described above. The sonic rod 19 is received within the wand 17, preferably fitting snugly into a sleeve or channel inside the wand for a snug fit that allows the vibration of the sonic rod to be directly transferred to the wand.

The separation of the wand from the handle further allows for the insertion of an amount of gel 18 into the wand 17. As described above, the gel may be placed within cavities formed on an outer surface of the tip of the wand. In one version, the gel may be in the form of gel capsules 18 that can be stored within an interior volume formed by the wand 17. In use, one or more capsules is removed from the wand and then pierced so that the gel can be placed within the one or more cavities formed on the tip of the wand.

In an alternate version, the gel is insertable into the same channel that receives the sonic rod, for example as illustrated in FIGS. 11 and 12. This channel further extends internally along the inside of the wand, terminating in holes 25 at the tip 11 of the wand.

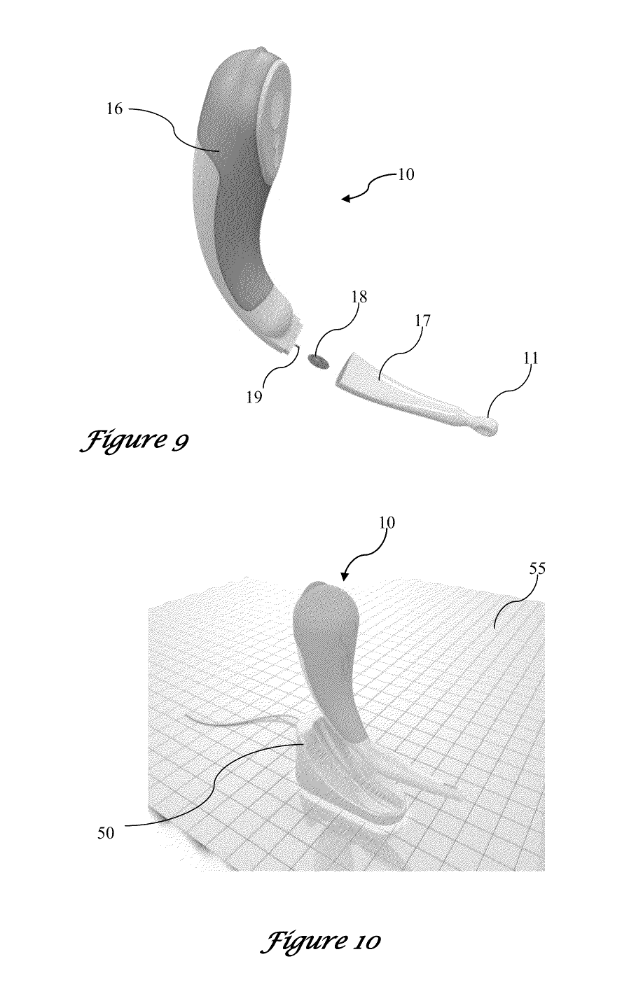

The device preferably includes internal batteries as described above, and is rechargeable by connection with a charging station 50, as shown in FIG. 10. The charging station is most preferably configured to be supported on a flat surface such as a countertop 55. In the illustrated example, the charging station uses inductive coupling between the charging station and the device to facilitate charging, thereby having no plugs or other exposed connectors on the device 10.

The device may be shaped differently than illustrated in FIG. 7, and in an example alternate version the wand portion 17 may be straight rather than curved. One such version is illustrated in FIG. 11, which shows an exemplary wand together with a partial cutaway portion of a handle 16. In this version the handle includes a flared portion 27 adjacent a location where the removable wand 17 connects to the handle, and in this case the flared portion is a more uniformly shaped cone rather than the bulbous knob as in the version of FIG. 7. The sonic rod 19 is centrally located on the handle, and extends into a sleeve formed within a proximal end 28 of the wand. At the distal end, or tip 11, of the wand, one or more holes 25 is formed. The holes are part of a passageway extending from the sleeve at the proximal end of the wand, through the length of the wand, and out the holes at the tip of the wand. Accordingly, gel or other fluids inserted into the channel or sleeve for receiving the sonic wand can travel through the passageway and out the holes formed at the tip. A closure 26, preferably in the form of tape or an adhesive strip, is removably attached to the tip 11 of the wand in order to cover the holes 25 to prevent gel leakage prior to use.

In a version in accordance with FIG. 11, where the wand is removable from the handle, the wand may be configured to be disposable for single use. Alternatively, the wand may be used multiple times, preferably by cleaning any gel from the interior of the wand between uses.

In some versions of the invention, the housing further includes a heating circuit for producing heat that can be communicated to the sonic rod. The rod is thereby heated by the heating circuit for selectively heating the wand 17. The heating of the wand may be selectively controlled by the user interface to allow for no heat, heat at a desired level, or a regimen of varying heat applications over time.

In yet another version, the wand may be configured to deliver a mild electrical current. In such a version, the internal batteries that are preferably stored in the housing of the device are electrically coupled to a portion of the wand that is metallic or otherwise electrically conductive. Under operation of the processor, the batteries deliver a low-level electrical current to the tip of the wand over a time and duration in accordance with the particular regimen.

In each case, the data delivered to the remote computer preferably includes the particular regimen followed, together with the sensor data such as the color, moisture, and elasticity. As these data are tracked over time they can be associated with particular regimens in an effort to associate particular therapies (vibration types and durations, heat, current, timing, and other parameters) with the most beneficial changes in the sensed data.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A perineal massage device, comprising:
a housing forming a handle, the housing having a motor coupled to a rod for producing vibrations external to the handle;
a wand coupled to the handle, the wand being configured to vibrate under control of the motor and the rod;
a user interface positioned on the device, the user interface including controls configured to operate the device; and
a processor and a memory, the memory containing stored programming instructions operable by the processor to cause the motor to operate in accordance with an operating regimen.

2. The perineal massage device of claim 1, wherein the housing further comprises a channel formed in the wand, the channel forming a passageway through a central portion of the wand and terminating in an outlet formed at a distal end of the wand, the channel and outlet being sized and configured to enable a fluid to travel through passageway and the outlet.

3. The perineal massage device of claim 1, further comprising one or more sensors positioned on the wand.

4. The perineal massage device of claim 3, wherein the one or more sensors comprises a photodetector.

5. The perineal massage device of claim 3, wherein the one or more sensors comprises a moisture detector.

6. The perineal massage device of claim 1, wherein the operating regimen comprises variations in the frequency of the vibration over a time duration for the regimen.

7. The perineal massage device of claim 1, wherein the housing further comprises a heating element and further wherein the operating regimen comprises control of the operation of the heating element over a time duration for the regimen.

8. The perineal massage device of claim 1, wherein the wand further comprises one or more concavities positioned at a tip of the wand, the concavities being configured to receive a volume of gel.

9. The perineal massage device of claim 1, wherein the wand is removably attached to the handle.

10. The perineal massage device of claim 1, wherein the wand extends along a first axis and the handle extends along a second axis, the first axis intersecting the second axis at an angle of between 60 degrees and 120 degrees.

11. The perineal massage device of claim 1, wherein the device further includes a wireless communication interface, the wireless communication interface being configured to communicate with a remote computing device.

12. The perineal massage device of claim 11, wherein the remote computing device is a smartphone, and further wherein the smartphone is configured to operate an application configured to enable a user to send commands from the smartphone to the device, whereby the commands control the operation of the device.

13. The perineal massage device of claim 11, wherein the remote computing device includes one or more additional stored operating regimens, the remote computing device further being configured to send the one or more additional stored operating regimens to the device over the wireless communication interface.

14. The perineal massage device of claim 11, wherein the remote computing device includes one or more additional stored operating regimens, the remote computing device further being configured to remotely control the device by sending commands to the device in accordance with the one or more additional stored operating regimens.

15. The perineal massage device of claim 11, wherein the stored programming instructions in the device are configured to send stored usage data to the remote computer.

16. The perineal massage device of claim 13, wherein stored usage data includes one or more of the frequency, duration, and timing of use of the device.

17. The perineal massage device of claim 16, wherein the wand further comprises one or more sensors positioned on the wand, and further wherein the stored usage data comprises stored sensor data.

18. The perineal massage device of claim 17, wherein the one or more sensors comprise a photodetector, and further wherein the device is configured to transfer photodetector data to the remote computer.

19. The perineal massage device of claim 18, wherein the remote computer stores the photodetector data over time, and is configured to present the stored photodetector data.

20. The perineal massage device of claim 17, wherein the one or more sensors comprise a moisture detector, and further wherein the device is configured to transfer moisture data to the remote computer.
